(19) United States
(12) Patent Application Publication
(10) Pub. No.: US 2010/0058206 A1
(43) Pub. Date: Mar. 4, 2010

(54) User Interface Configuration Tool

(75) Inventors: Britta Ollrogge, Heidelberg (DE); Tim Back, Mannheim (DE); Florian Weigmann, Karlsruhe (DE); Peter Hahn, Mannheim (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 12/203,615

(22) Filed: Sep. 3, 2008

(51) Int. Cl. G06F 3/00

(52) U.S. Cl. 715/762

(57) ABSTRACT

A computer-implemented method may include receiving a first input selection from a user made while in a page of an application, providing an indication to the user of one or more views on the page of the application that are user configurable, in response to receiving the first input selection, receiving a second input selection from the user of one of the views, and instantiating a user interface (UI) configuration tool to enable the user to configure the selected view, in response to receiving the second input selection.

### TECHNICAL FIELD

This description relates to a user interface (UI) configuration tool.

### BACKGROUND

A software application may allow a user to customize the user interface related to the application. For example, the user may be able to change fields, labels for the fields, placement of the fields, as well as other information related to the user interface. In a business context, the user may be an administrator, who has been given the ability to customize the user interface for a group of other users. The administrator, in this example, may want to customize the user interface of the application to reflect their unique business needs and brands. Furthermore, the administrator may want to remove user interface elements that are not pertinent to the way the business operates, or may want to add user interface elements that may enhance the user interface as it relates to the application.

However, the process even to begin customizing the user interface related to the application may be tedious and time consuming (and therefore costly) as a certain level of technical expertise and knowledge about various user interfaces for the application may be required.

### SUMMARY

According to one general aspect, a computer-implemented method may include receiving a first input selection from a user made while in a page of an application, providing an indication to the user of one or more views on the page of the application that are user configurable, in response to receiving the first input selection, receiving a second input selection from the user of one of the views, and instantiating a user interface (UI) configuration tool to enable the user to configure the selected view, in response to receiving the second input selection.

Implementations may include one or more of the following features. For example, providing the indication to the user of the one or more views on the page of the application that are user configurable may include highlighting the one or more views on the page of the application that are user configurable, in response to receiving the first input selection. Receiving the second input selection may include receiving a selection of one of the highlighted views from the user.

Providing the indication to the user of the one or more views on the page of the application that are user configurable may include identifying and marking the one or more views as separately selectable frames for selection by the user. In one exemplary implementation, providing the indication to the user of the one or more view on the page of the application that are user configurable may include identifying and marking nested views within the one or more views as separately selectable frames for selection by the user.

Instantiating the UI configuration tool may include instantiating a pop-up window containing the UI configuration tool to enable the user to configure the selected view, in response to receiving the second input selection. Instantiating the UI configuration tool may include instantiating a pop-up window containing the UI configuration tool and transferring information from the selected view in substantially real time to the UI configuration tool to enable the user to configure the selected view, in response to receiving the second input selection.

The computer-implemented method may include displaying a current configuration of parameters for the selected view in the UI configuration tool. The computer-implemented method may include receiving configuration changes for the selected view within the UI configuration tool and updating the selected view within the page of the application to reflect the received configuration changes.

In another general aspect, a computer program product for accessing a user interface (UI) configuration tool may be tangibly embodied on a computer-readable medium and may include executable code that, when executed, is configured to cause a data processing apparatus to receive a first input selection from a user made while in a page of an application, provide an indication to the user of one or more views on the page of the application that are user configurable, in response to receiving the first input selection, receive a second input selection from the user of one of the views, and instantiate a user interface (UI) configuration tool to enable the user to configure the selected view, in response to receiving the second input selection.

Implementations may include one or more of the following features. For example, The computer program product may cause the data processing apparatus to highlight the one or more views on the page of the application that are user configurable, in response to receiving the first input selection. The computer program product may cause the data processing apparatus to receive a selection of one of the highlighted views from the user.

The computer program product may cause the data processing apparatus to identify and mark the one or more views as separately selectable frames for selection by the user. In one exemplary implementation, the computer program product may cause the data processing apparatus to identify and mark nested views within the one or more views as separately selectable frames for selection by the user.

The computer program product may cause the data processing apparatus to instantiate a pop-up window containing the UI configuration tool to enable the user to configure the selected view, in response to receiving the second input selection. The computer program product may cause the data processing apparatus to instantiate a pop-up window containing the UI configuration tool and transfer information from the selected view in substantially real time to the UI configuration tool to enable the user to configure the selected view, in response to receiving the second input selection.

The executable code of the computer program product may be configured to cause the data processing apparatus to display a current configuration of parameters for the selected view in the UI configuration tool. The executable code of the computer program product may be configured to cause the data processing apparatus to receive configuration changes for the selected view within the UI configuration tool and update the selected view within the page of the application to reflect the received configuration changes.

In another general aspect, a system may include an application module that is arranged and configured to receive a first input selection from a user made while in a page of an application, provide an indication to the user of one or more views on the page of the application that are user configurable, in response to receiving the first input selection, and receive a second input selection from the user of one of the views. The system may include a processor that is arranged and configured to instantiate a UI configuration tool to enable the user to configure the selected view, in response to receiving the second input selection.

Implementations may include one or more of the following features. For example, the processor may be arranged and configured to instantiate a pop-up window containing the UI configuration tool and the application module is arranged and configured to transfer information from the selected view in substantially real time to the UI configuration tool to enable the user to configure the selected view, in response to receiving the second input selection. Other implementations may include one or more of the features discussed above with respect to the other general aspects.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for accessing a user interface (UI) configuration tool.

FIGS. 2A and 2B are exemplary flowcharts illustrating example operations of the system of FIG. 1

FIGS. 3-8 are exemplary screen shots illustrating example operations of the system of FIG. 1 and the flowcharts of FIGS. 2A and 2B.

### DETAILED DESCRIPTION

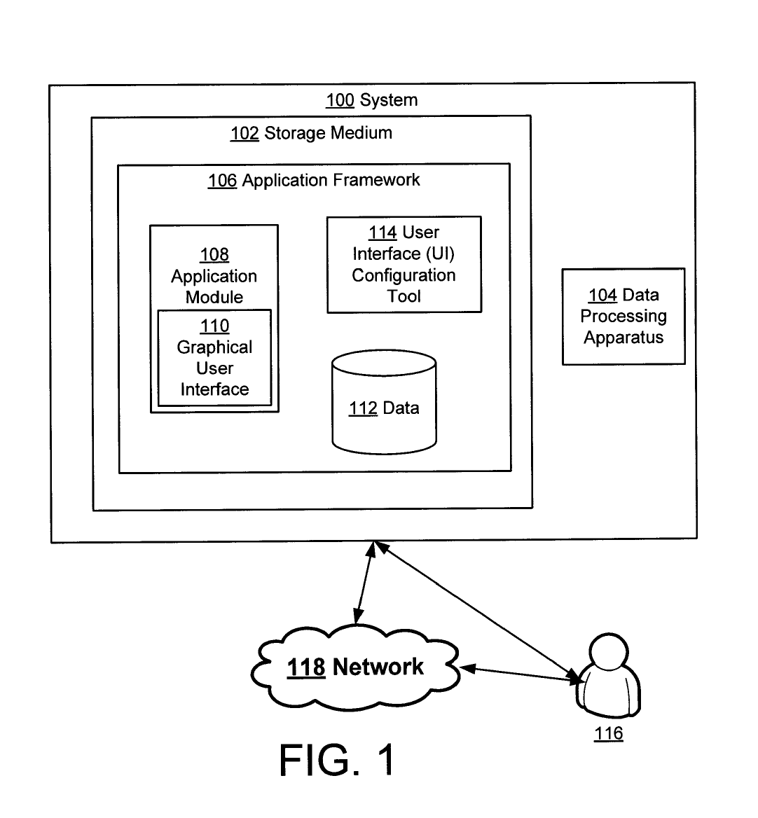

FIG. 1 is a block diagram of a system 100. The system 100 may be a computing device such as, for example, a server, a personal computer, a laptop computer, or any type of computing device. The system 100 may include a storage medium 102 and a data processing apparatus 104. The system 100 also may include other components and combinations of components to enable the operation and performance of the system 100. For example, if the system 100 is a computing device, then other components may include input/output devices, displays, buses, networking devices, communication devices and other components.

The storage medium 102 may include various different types of storages devices for storing data, including computer-readable media that store computer program products having executable code. The storage medium for storing data may include, for example, magnetic disks, magneto-optical disks, or optical disks. The storage medium 102 also may include all forms of non-volatile memory, including by way of example, semiconductor memory devices, for instance, read-only memory (ROM), programmable read-only memory (PROM), erasable programmable read-only memory (EPROM), electrically erasable programmable read-only memory (EEPROM), flash memory devices and magnetic disks such as, for example, internal hard disks or removable disks, magneto-optical disks, CD-ROM and DVD-ROM disks.

The data processing apparatus 104 may be configured to process data and to execute executable code which, when executed, causes the data processing apparatus to perform in a certain manner. The data processing apparatus 104 may include one or more processors suitable for the execution of a computer program product having executable code including, by way of example, both general and special purpose microprocessors, and any one or more processors of any kind of digital computer. Generally, the data processing apparatus 104 may interact with and receive instructions and data from the storage medium 102. System 100 also may include volatile memory such as, for example, random access memory (not shown), to which instructions and data may be loaded from the storage medium 102 for processing by the data processing apparatus 104.

In one exemplary implementation, the storage medium may include an application framework 104. The application framework 104 may be configured to provide the overall framework and modules/components for a particular application such as, for instance, a computer program product having executable code. The application framework 104 may include an application module 108 having a graphical user interface (GUI) 110, data 112, and a user interface (UI) configuration tool 114.

The application module 108 may include any type of application including business-related applications and consumer-oriented applications. The application module 108 includes a GUI 110 that enables a user 116 to interface with the application module 108. The user 116 may interact directly with the system 100 or the user 116 may interact with the system 100 using a network 118. References to the user 116 includes a user using a computing device to interact over the network 118 with the system 100. The user 116 includes users that may function as administrators of the system 100 and/or the application module 108 and includes end users who may use the system 100 and/or the application module 108 to perform certain tasks or functions. The network 118 may include any wired and/or wireless network including, for example, the Internet.

The UI configuration tool 114 may be a part of the application framework 106 and may interact with the application module 108. The UI configuration tool 114 may be configured to enable the user 116 to configure the GUI 110 that is presented to the user 116. For example, the UI configuration tool 114 may be configured to enable the user 116 to customize the GUI 110 in many different ways for different users and different types of users. The application module 108 may have many different components and pages that may be viewable by users. Each of the pages that are viewable may include one or more views within the page, where each of the views within the page may be user configurable using the UI configuration tool 114.

For example, many users in an organization may have access to the application module 108 in order to perform their job function. The application module 108 may have many different configurable views that may be configured for different users based on, for example, their particular job function and/or their particular level of authorization or access level. Users may have different levels of access to the application module 108 and the data 112 that they may be able to view and manipulate through the application module 108. The UI configuration tool 114 enables different customizations of the different views for these many users.

In one exemplary implementation, the UI configuration tool 114 may be instantiated from within the application module 108 without having to go outside the application module 108 to start the UI configuration tool 114. The application module 108 may be configured to receive an input selection from the user 116 made while in a page of an application. The application module 108 may provide an indication to the user 116 of one or more views on the page of the application that are user configuration, in response to receiving the input selection from the user 116. The application module 108 may receive an input selection of one of the views. For example, the user 116 may wish to customize and change the configuration of the selected view. The data processing apparatus 104 may be configured to instantiate the UI configuration tool 114 to enable the user to configure the selected view, in response to receiving the second input selection.

When a view if selected for configuration and the UI configuration tool 114 is instantiated, data 112 may be transferred to the UI configuration tool 114 related to the selected view. Since the UI configuration tool 114 is instantiated from within the application module 108 itself, the application module 108 can automatically provide the information needed by the UI configuration tool 114 for the selected view without the user 116 having to supply any information about the selected view. The correct technical information is determined automatically and transferred from run time to the UI configuration tool 114. Thus, the appropriate information may be data mined from the application module 108 and/or the data 112 to populate the UI configuration tool 114. Instantiating the UI configuration tool 114 from within the application module 108 makes it very user-friendly for the user 116 to make configuration changes, especially for the user 116 serving in an administrative role who is responsible for configuring the GUI 110 having many different views for an organization. The user 116 does not need to know the technical or other information in order to instantiate the UI configuration tool 114 and to have it automatically populated with the correct information for the selected view.

In one exemplary implementation, the UI configuration tool 114 is instantiated in a separate window, e.g. pop-up window. The UI configuration tool 114 receives the inputs from the user 116 for configuration changes to the view. The user 116 may save the changes and upon saving the changes and/or upon closing the UI configuration tool 114, the configuration changes may be made to the application module 108 such that the user 116 can see the results of the changes. The changes may be immediately visible to the user 116.

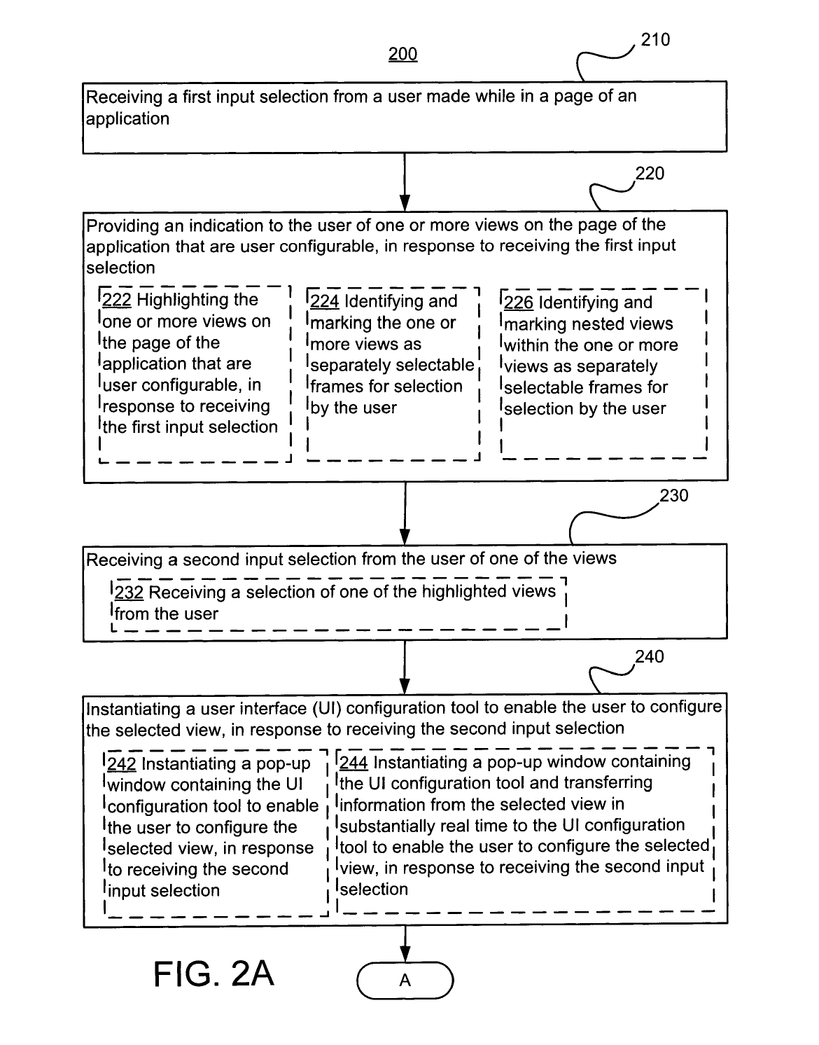

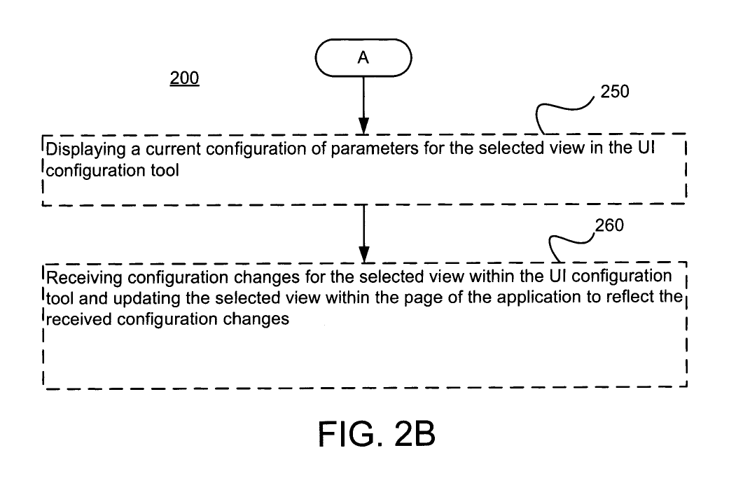

Referring also to FIG. 2A, a process 200 is illustrated showing example operations of the system 100. Process 200 may include receiving a first input selection from a user made while in a page of an application (210), providing an indication to the user of one or more views on the page of the application that are user configurable in response to receiving the first input selection (220), receiving a second input selection from the user of one of the views (230), and instantiating a UI configuration tool to enable the user to configure the selected view, in response to receiving the second input selection (240).

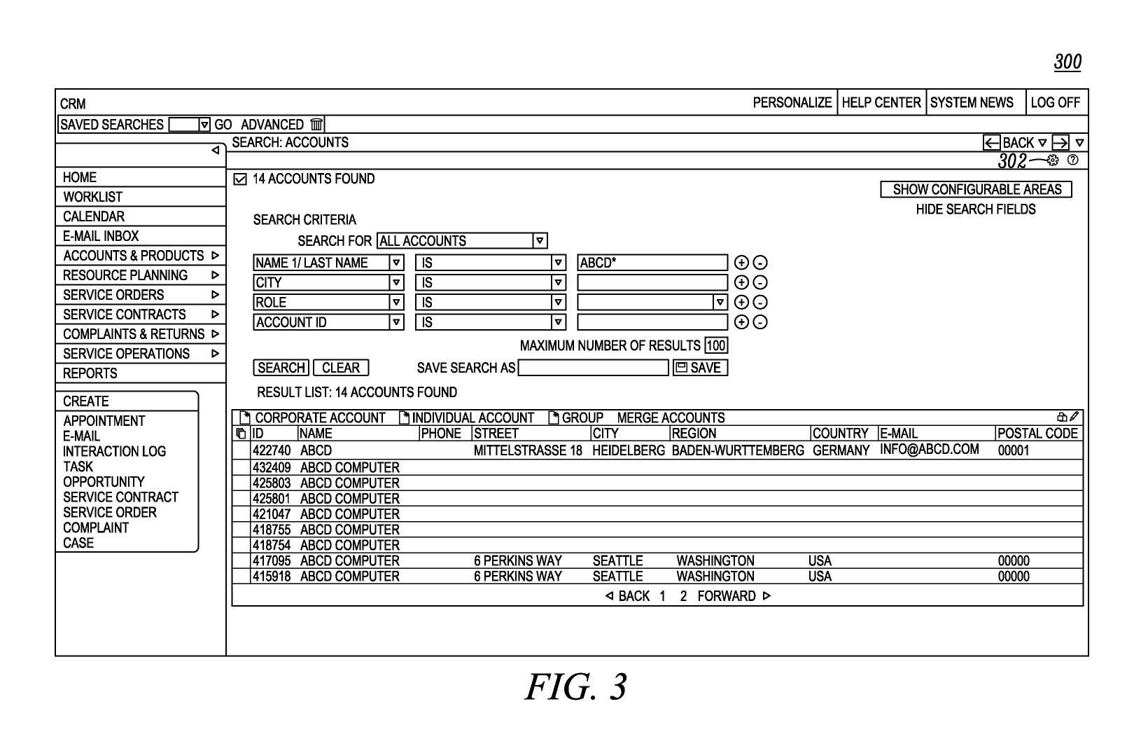

For example, the application module 108 may be configured to receive the first input selection from the user 116 made while in a page of the application (210). The first input selection may be made in various different ways. In one exemplary implementation, the application page may include a button for selection by the user 116. Referring also to FIG. 3, an exemplary screen shot 300 is illustrated. Screen shot 300 illustrates a page from a customer relationship management (CRM) application. The CRM application is one example of an application module 108. In this example, the application framework 106 may be a CRM framework for all of the components to run and operate the CRM application. Screen shot 300 may include a button 302 that is labeled as “Show Configurable Areas.” The user 116 may select the button 302 to see which view(s) on the page may be user configurable.

The button 302 may be made accessible or active to users that have the appropriate level of authorization or access. Thus, the application module 108 may determine whether or not a particular user has the appropriate credentials or clearance to make configuration changes before making the button 302 available to the user.

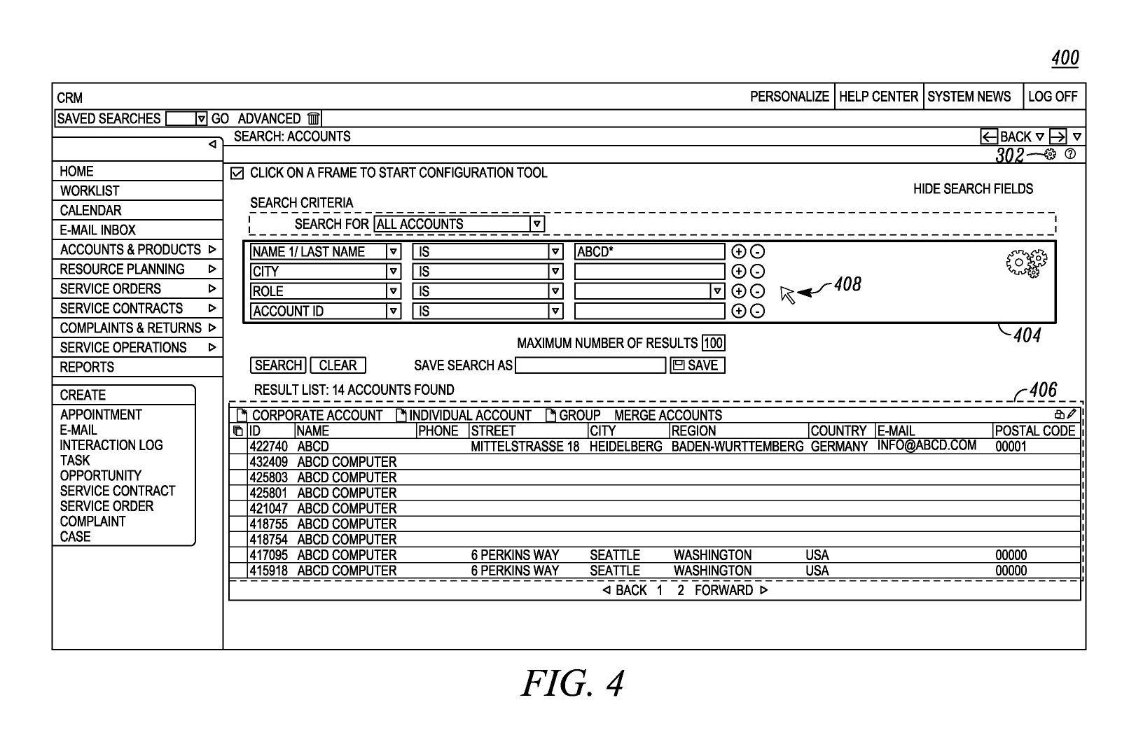

The application module 108 may be configured to provide the indication to the user of one or more views on the page of the application that are user configurable, in response to receiving the first input selection (220). Thus, the selection of the button 302 causes the application module 108 to provide an indication to the user 116 of which views on the screen shot 300 are user configurable. Referring also to FIG. 4, an exemplary screen shot 400 illustrates providing the indication to the user of the one or more views that are user configurable. In screen shot 400, the application module 108 provides the indication that a first view 404 and a second view 406 are user configurable. In this example, the first view 404 and the second view 406 are each marked in dashed lines to indicate to the user 116 that each of these views are user configurable.

Providing the indication that one or more views on the page of the application are user configurable may include highlighting the one or more views of the page of the application that are user configurable, in response to receiving the first input selection (222). For example, the application module 108 may be configured to highlight the views on the page of the application that are user configurable in response to selection of the button 302 (222). In the screen shot 400, the first view 404 and the second view 406 may be highlighted in a way that makes them stand out or visibly distinguishable from the rest of the page. The highlighting may include making the dashed lines bold and/or colored.

Providing the indication to the user of the one or more views on the page of the application are user configurable may include identifying and marking the one or more views as separately selectable frames for selection by the user (224). For example, the application module 108 may be configured to mark and to identify the views such that it is apparent to the user 116 that each of the views are separately selectable frames (224). In the screen shot 400, the dashed lines of the first view 404 and the second view 406 mark and identify those views 404 and 406 as separately selectable frames. Additionally, other indicators may be provided to the user to indicate that each of the views 404 and 406 is separately selectable. For example, when the user hovers over one of the views with a pointer, the entire view may be highlighted in a way that visually distinguishes it over the rest of the page and the other views. In screen shot 400, the first view 404 is illustrated as being colored in as the pointer 408 hovers over the first view 404.

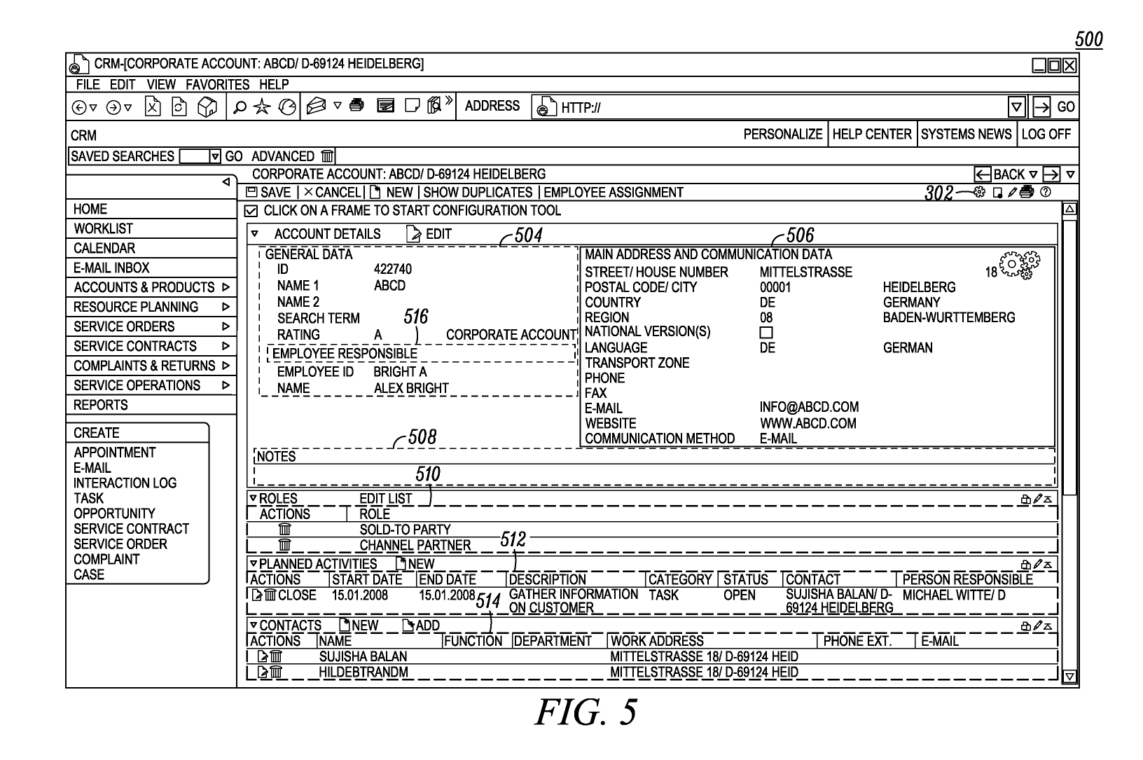

Providing the indication to the user of the one or more views on the page of the application are user configurable may include identifying and marking nested views within the one or more views as separately selectable frames for selection by the user (226). For example, the application module 108 may be configured to mark and identify the nested views within the one or more views as separately selectable frames for selection by the user (226). Referring also to FIG. 5, an exemplary screen shot 500 illustrates multiple views 504, 506, 508, 510, 512, and 514 that are marked and identified as separately selectable configurable views. Screen shot 500 also illustrates a nested view 516, which is a view within the view 504. The nested view 516 also is marked and identified as being a separately selectable frame. A view may have one or more nested views and nested views may have one or more nested views. The application module 108 may be configured to make each of the nested views, e.g. nested view 516, identifiable to the user as a view that is user configurable.

The application module 108 may be configured to receive a second input selection from the user of one of the views (230). Referring back to FIG. 4, for example, the user 116 may select the first view 404. Receiving the second input selection may include receiving a selection of one of the highlighted views from the user (232). For instance, the application module 108 may be configured to receive the selection of one of the highlighted views (232) such as highlighted first view 404.

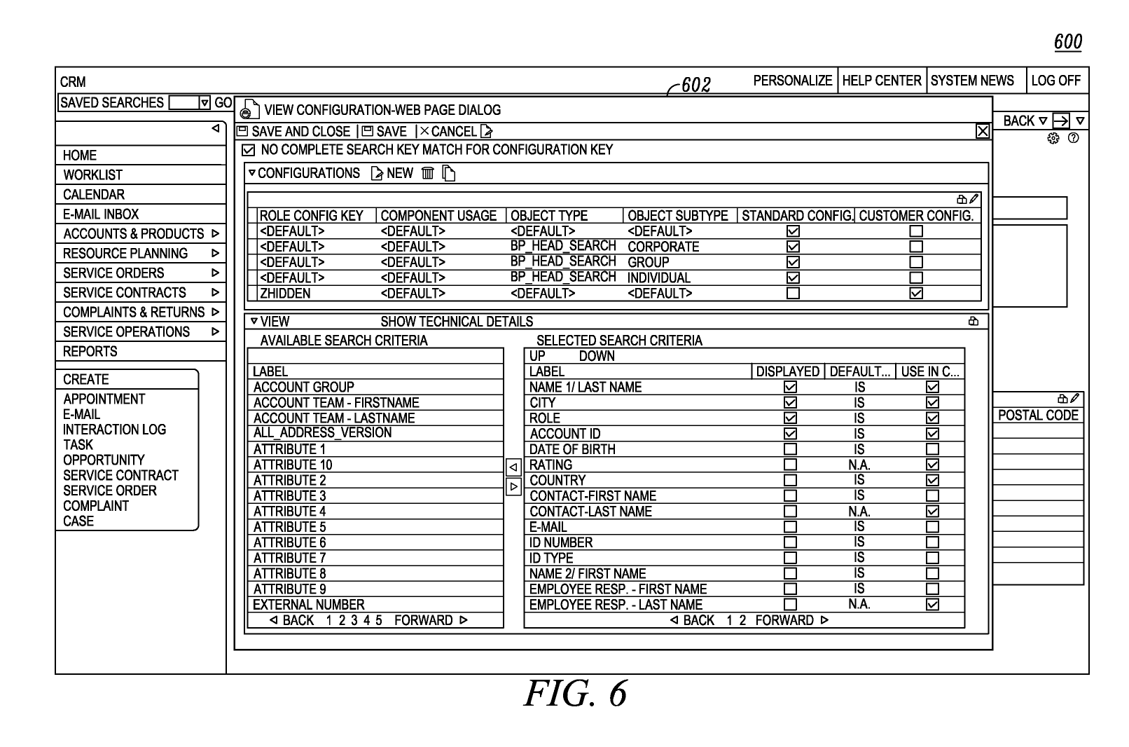

The data processing apparatus 104 may be configured to instantiate the UI configuration tool 114 to enable the user to configure the selected view, in response to the application module 108 receiving the second input selection (240). For example, the user may select the first view 404. In response to the selection of the first view 404, the UI configuration tool 114 may be instantiated. Referring to FIG. 6, an exemplary screen shot 600 illustrates the instantiation of the UI configuration tool 114, which is shown in window 602. The UI configuration tool enables the user to configure the selected view such as, for example, by adding or deleting fields, re-labeling the fields, marking fields as view only or as mandatory, as well as many other types of configuration changes.

Instantiating the UI configuration tool may include instantiating a pop-up window containing the UI configuration tool to enable the user to configure the selected view, in response to receiving the second input selection (242). For example, the data processing apparatus 104 may be configured to instantiate the pop-up window containing the UI configuration tool 114 (242). Window 602 is provided as an example of the pop-up window that includes the UI configuration tool.

Instantiating the UI configuration tool may include instantiating a pop-up window containing the UI configuration tool and transferring information from the selected view in substantially real time to the US configuration tool to enable the user to configure the selected view, in response to receiving the second input selection (244). For example, the data processing apparatus 104 may be configured to instantiate the pop-up window 602. The application module 108 and/or the data processing apparatus 104 may be configured to transfer the run time information from the application related to the selected view and populate the UI configuration tool 114 with this information. The transferred information may include configuration data and other data pulled from the data 112. Each configurable view may have different configurations, where each of the configurations for the view include an XML entry in the data 112.

Referring also to FIG. 2B, process 200 may further include displaying a current configuration of parameters for the selected view in the UI configuration tool (250) and receiving configuration changes for the selected view within the UI configuration tool and updating the selected view within the page of the application to reflect the received configuration changes (260). For example, UI configuration tool 114 may be configured to display the current configuration of parameters for the selected view (250). Window 602 illustrates the current configuration parameters for the first view 404, which was selected by the user. The configuration information for the first view 404 is populated in the UI configuration tool without any input from the user, other than the simple selection of the first view 404.

The UI configuration tool 114 may be configured to receive the configuration changes for the selected view and to update the data 112 and the application module 108 such that the selected view reflects the changes (260). For example, the user 116 may enter configuration changes in the UI configuration tool 114 and save those changes. When the changes are saved and/or when the user exits from the UI configuration tool 114, those changes are written to the data 112 and reflected in the application module 108 such that the user is able to immediately see the changes that were made to the selected view.

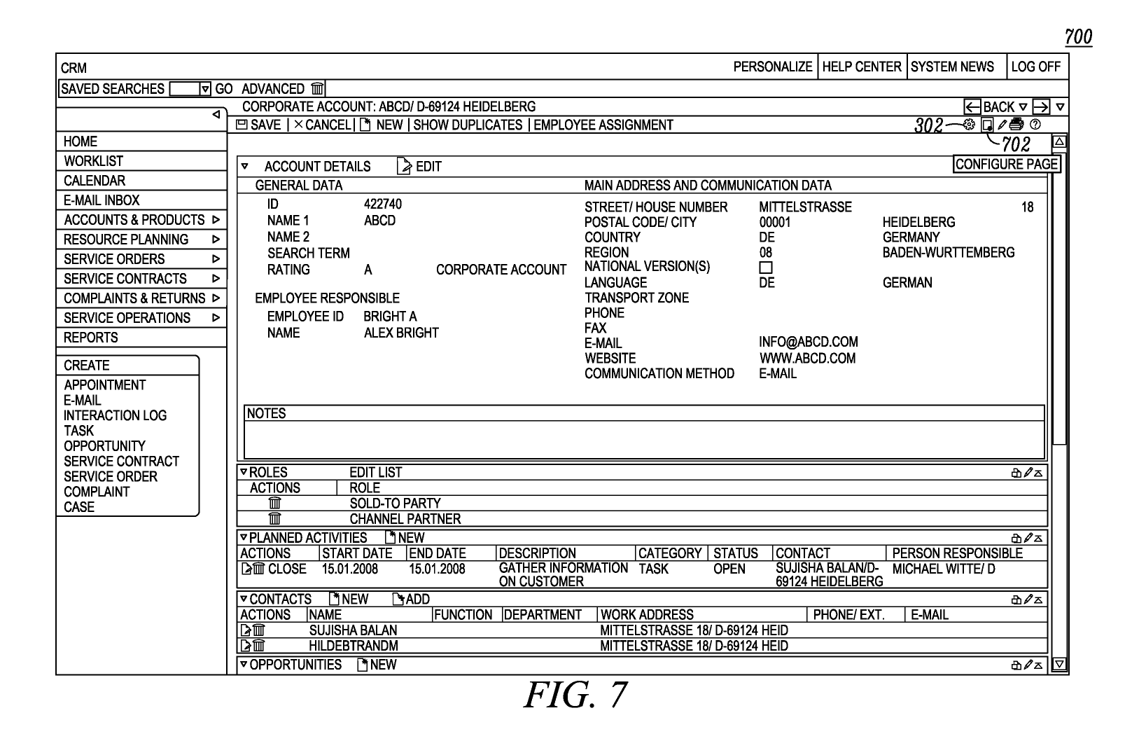

In one exemplary implementation, the application module 108 may be configured to enable the user to instantiate the UI configuration tool 114 to make changes to the layout of the page. Referring to FIG. 7, an exemplary screen shot 700 is illustrated. In this example, the user may first select button 302 to show the views that are user configurable. The user also may select button 702, which is labeled as “Configure Page.” The selection of the button 702 causes the instantiation of the UI configuration tool 114 and enables the user to make configuration changes to the overall page view.

In another exemplary implementation, the application module 108 may be configured to receive a first input selection from a user made within a page of an application (210), where the first input selection is the selection of a key on the keyboard. For instance, the application module 108 may be configured to accept as the first input one of the function keys such as the F2 key. In this example, the selection of the F2 key may cause the application module 108 to pull up a window with the technical data related to the page in the application that the user is currently viewing.

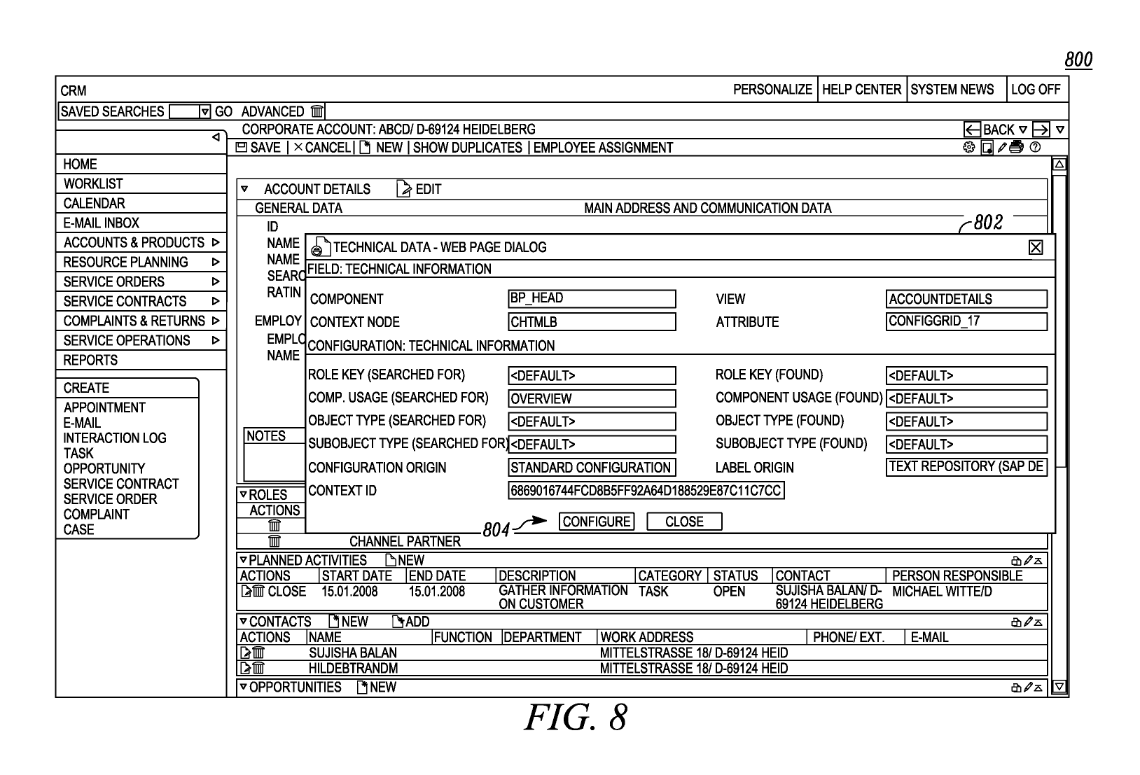

Referring also to FIG. 8, an exemplary screen shot 800 illustrates a pop-up window 802 that may be instantiated upon selection of a key such as, for example, the F2 key. The pop-up window 802 is populated by the application module 108 with technical data related to the page being viewed by the user. Upon a second input selection from the user (230), the UI configuration tool 114 is instantiated (240). For example, upon selection of the configure button 804, the UI configuration tool 114 is instantiated. The UI configuration tool 114 is populated with the information about the selected view to enable the user to make configuration changes for the selected view. As discussed above, any configuration changes made to the selected view are made immediately visible to the user.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method comprising:
receiving a first input selection from a user made while in a page of an application;
providing an indication to the user of one or more views on the page of the application that are user configurable, in response to receiving the first input selection;
receiving a second input selection from the user of one of the views; and
instantiating a user interface (UI) configuration tool to enable the user to configure the selected view, in response to receiving the second input selection.

2. The computer-implemented method as in claim 1 wherein providing the indication to the user of the one or more views on the page of the application that are user configurable comprises highlighting the one or more views on the page of the application that are user configurable, in response to receiving the first input selection.

3. The computer-implemented method as in claim 2 wherein receiving the second input selection comprises receiving a selection of one of the highlighted views from the user.

4. The computer-implemented method as in claim 1 wherein providing the indication to the user of the one or more views on the page of the application that are user configurable comprises identifying and marking the one or more views as separately selectable frames for selection by the user.

5. The computer-implemented method as in claim 1 wherein providing the indication to the user of the one or more view on the page of the application that are user configurable comprises identifying and marking nested views within the one or more views as separately selectable frames for selection by the user.

6. The computer-implemented method as in claim 1 wherein instantiating the UI configuration tool comprises instantiating a pop-up window containing the UI configuration tool to enable the user to configure the selected view, in response to receiving the second input selection.

7. The computer-implemented method as in claim 1 wherein instantiating the UI configuration tool comprises:
instantiating a pop-up window containing the UI configuration tool; and
transferring information from the selected view in substantially real time to the UI configuration tool to enable the user to configure the selected view, in response to receiving the second input selection.

8. The computer-implemented method as in claim 1 further comprising displaying a current configuration of parameters for the selected view in the UI configuration tool.

9. The computer-implemented method as in claim 1 further comprising:
receiving configuration changes for the selected view within the UI configuration tool; and
updating the selected view within the page of the application to reflect the received configuration changes.

10. A computer program product for accessing a user interface (UI) configuration tool, the computer program product being tangibly embodied on a computer-readable medium and including executable code that, when executed, is configured to cause a data processing apparatus to:
receive a first input selection from a user made while in a page of an application;
provide an indication to the user of one or more views on the page of the application that are user configurable, in response to receiving the first input selection;
receive a second input selection from the user of one of the views; and
instantiate a user interface (UI) configuration tool to enable the user to configure the selected view, in response to receiving the second input selection.

11. The computer program product of claim 10 wherein causing the data processing apparatus to provide the indication to the user of the one or more views on the page of the application that are user configurable comprises causing the data processing apparatus to highlight the one or more views on the page of the application that are user configurable, in response to receiving the first input selection.

12. The computer program product of claim 11 wherein causing the data processing apparatus to receive the second input selection comprises causing the data processing apparatus to receive a selection of one of the highlighted views from the user.

13. The computer program product of claim 10 wherein causing the data processing apparatus to provide the indication to the user of the one or more views on the page of the application that are user configurable comprises causing the data processing apparatus to identify and mark the one or more views as separately selectable frames for selection by the user.

14. The computer program product of claim 10 wherein causing the data processing apparatus to provide the indication to the user of the one or more view on the page of the application that are user configurable comprises causing the data processing apparatus to identify and mark nested views within the one or more views as separately selectable frames for selection by the user.

15. The computer program product of claim 10 wherein causing the data processing apparatus to instantiate the UI configuration tool comprises causing the data processing apparatus to instantiate a pop-up window containing the UI configuration tool to enable the user to configure the selected view, in response to receiving the second input selection.

16. The computer program product of claim 10 wherein causing the data processing apparatus to instantiate the UI configuration tool comprises causing the data processing apparatus to:
instantiate a pop-up window containing the UI configuration tool; and
transfer information from the selected view in substantially real time to the UI configuration tool to enable the user to configure the selected view, in response to receiving the second input selection.

17. The computer program product of claim 10 wherein the executable code is further configured to cause the data processing apparatus to display a current configuration of parameters for the selected view in the UI configuration tool.

18. The computer program product of claim 10 wherein the executable code is further configured to cause the data processing apparatus to:
receive configuration changes for the selected view within the UI configuration tool; and
update the selected view within the page of the application to reflect the received configuration changes.

19. A system, comprising:
an application module that is arranged and configured to:
receive a first input selection from a user made while in a page of an application,
provide an indication to the user of one or more views on the page of the application that are user configurable, in response to receiving the first input selection, and
receive a second input selection from the user of one of the views; and
a processor that is arranged and configured to instantiate a UI configuration tool to enable the user to configure the selected view, in response to receiving the second input selection.

20. The system of claim 19 wherein:
the processor is arranged and configured to instantiate a pop-up window containing the UI configuration tool; and
the application module is arranged and configured to transfer information from the selected view in substantially real time to the UI configuration tool to enable the user to configure the selected view, in response to receiving the second input selection.
